(19) United States
(12) Patent Application Publication
(10) Pub. No.: US 2008/0176515 A1
(43) Pub. Date: Jul. 24, 2008

(54) Wireless hotspot detection system and method

(76) Inventor: Paul E. Hiles, Tomball, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/655,473

(22) Filed: Jan. 19, 2007

(51) Int. Cl. H04B 7/00

(52) U.S. Cl. 455/41.2

(57) ABSTRACT

A wireless hotspot detection system comprises a hotspot detection module configured to detect a wireless hotspot and activate a wireless module in response to the detection of the wireless hotspot.

### BACKGROUND

As a wireless electronic device is transported between wireless hotspots, a radio module of the device actively and continuously searches for the nearest and/or desired wireless network. The continuous operation of the radio module requires substantial power, which significantly decreases the available battery life of the electronic device.

### BRIEF DESCRIPTION OF THE DRAWINGS

FIG. 1 is a block diagram illustrating an exemplary wireless local area network in which an embodiment of a wireless hotspot detection system is employed to advantage;

FIG. 2 is a block diagram illustrating a portion of the wireless local area network of FIG. 1 in which the wireless hotspot detection system is employed to advantage; and

FIG. 3 is a flow diagram illustrating an embodiment of a wireless hotspot detection method.

### DETAILED DESCRIPTION OF THE DRAWINGS

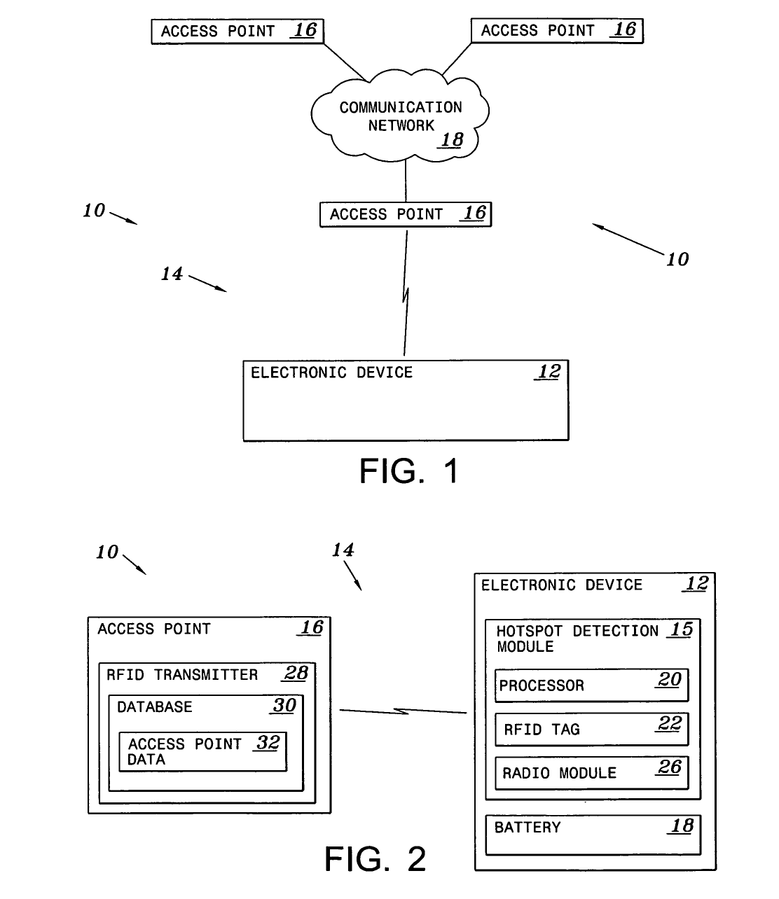

The preferred embodiments and the advantages thereof are best understood by referring to FIGS. 1-3, like numerals being used for like and corresponding parts of the various drawings.

FIG. 1 is a block diagram illustrating an exemplary wireless local area network 10 in which a wireless hotspot detection system 14 is employed to advantage. For convenience, the term “wireless network” used herein refers to any type of wireless network such as, but not limited to, a wireless local area network (WLAN), a wireless wide area network (WWAN) or any other type of wireless network. Embodiments are described below in connection with WLANs; however, it should be understood that embodiments may be used to advantage in any type of wireless network.

In the embodiment illustrated in FIG. 1, an electronic device 12 is configured to access and/or otherwise connect to wireless network 10. Electronic device 12 may comprise any type of electronic device with wireless capabilities such as, but not limited to, a notebook computer, a tablet computer, a cellular phone, a personal digital assistant, a camera, or any other portable or non-portable electronic device. Electronic device 12 is operable to communicate and/or otherwise connect wirelessly with one or more access points (AP) 16 of wireless network 10 based on a location of electronic device 12 relative to a geographic boundary covered by a particular AP 16 (e.g., a hotspot). Each AP 16 is communicatively coupled with a communication network 18, such as the Internet, an intranet, an extranet, and/or the like. In wireless network 10, each AP 16 coordinates communications between communication network 18 and electronic device 12. In some embodiments, communication network 18 is based on an IEEE 802.11 wireless network standard for communication; however, it should be understood that any other wireless network standard may be utilized. Hotspot detection system 14 is used to automatically detect the presence of a hotspot without powering a radio module contained within electronic device 12.

FIG. 2 is a block diagram illustrating a portion of wireless network 10 of FIG. 1 in which hotspot detection system 14 is employed to advantage. In the embodiment illustrated in FIG. 2, hotspot detection system 14 comprises a hotspot detection module 15 disposed in electronic device 12 and a radio frequency identification (RFID) transmitter 28 disposed in and/or otherwise associated with AP 16. In the embodiment illustrated in FIG. 2, a portion of hotspot detection system 14 is disposed within electronic device 12 and a portion of system 14 forms a part of AP 16; however, it should be understood that all or a portion of detection system 14 may be disposed within electronic device 12 or AP 16. In FIG. 2, electronic device 12 also comprises a battery 18. According to some embodiments, hotspot detection module 15 comprises a processor 20, a RFID tag 22, and a radio module 26 such as a wireless local area network (WLAN) radio module. In the embodiment illustrated in FIG. 2, RFID tag 22 comprises a passive RFID tag and is communicatively coupled to processor 20, although it should be understood that other types of RFID tags may be utilized (e.g., an active RFID tag). Hotspot detection module 15 is utilized to detect the presence of a hotspot while radio module 26 is turned off or is in an otherwise non-powered state, or alternatively, while in a hibernation mode (e.g., a reduced power mode permitting the hardware for radio module 26 to remain configured for communication with wireless network 10 upon detection of the hotspot). Accordingly, in some embodiments, electronic device 12 is configured to detect the presence of hotspots without using radio module 26, thereby reducing an amount of power draw from battery 18. In some embodiments, hotspot detection module 15 is configured to turn off and/or otherwise configure radio module 26 in a hibernation mode when it is determined that electronic device 12 is no longer within a hotspot (e.g., when radio module 26 is no longer in communicative contact with AP 16) to extend the useful life of battery 18.

In operation, RFID transmitter 28 continuously and/or at predetermined intervals broadcasts/transmits an electromagnetic signal within and/or up to the outer geographic boundary of a particular AP 16. Thus, when electronic device 12 is within range of transmitter 28, the electromagnetic signal energizes tag 22 in module 15, thereby indicating the presence of a hotspot. It should be understood that in FIG. 2, RFID transmitter 28 is illustrated as being communicatively coupled to AP 16 such that the functionality of RFID transmitter 28 resides within AP 16; however, it should be understood that RFID transmitter 28 may be a separate and discrete component apart from a communicatively coupled wireless AP 16. In operation, in response to tag 22 being energized via the electromagnetic signal generated by RFID transmitter 28, tag 22 sends a notification signal to processor 20 indicating the presence of the hotspot in which the electronic device 12 is located. In response to the notification, processor 20 sends a notification signal to power, wake and/or turn on radio module 26. Correspondingly, in response to radio module 26 losing contact with AP 16 (e.g., radio module 26 losing signal from AP 16), processor 20 sends a notification signal to turn off radio module 26. It should be understood that other methods of turning off or reducing power consumption by radio module 26 may be utilized, such as for example, monitoring whether tag 22 is energized or de-energized. For example, if the transmission/broadcasting area of RFID transmitter 28 is equal to or substantially equal to the geographic boundary AP 16, as tag 22 is de-energized (e.g., when tag 22 is outside the broadcasting range of transmitter 28 and thus the hotspot), tag 22 sends a notification signal to processor 20, which indicates that electronic device 12 is no longer within a hotspot. Processor 20 then sends a command to turn off radio module 26.

According to some embodiments, RFID transmitter 28 comprises a database 30 containing access point data 32 (e.g., configuration information for a particular AP 16 indicative of a characteristic of access point 16) to identify and/or otherwise facilitate communications by electronic device 12 with communication network 18 via AP 16 (FIG. 1). For example, in some embodiments, access point data 32 comprises the access point name (e.g., the SSID), the security method in use by AP 16, wireless equivalency protocol (WEP) encryption keys, and any other certification/security key information. However, it should be understood that access point data 32 may comprise additional and/or other characteristics associated with the wireless hotspot. Accordingly, in operation, processor 20 reads access point data 32 from tag 22 and then communicates the access point data 32 to radio module 26 to enable radio module 26 to automatically connect to and communicate with communication network 18 (e.g., without user intervention).

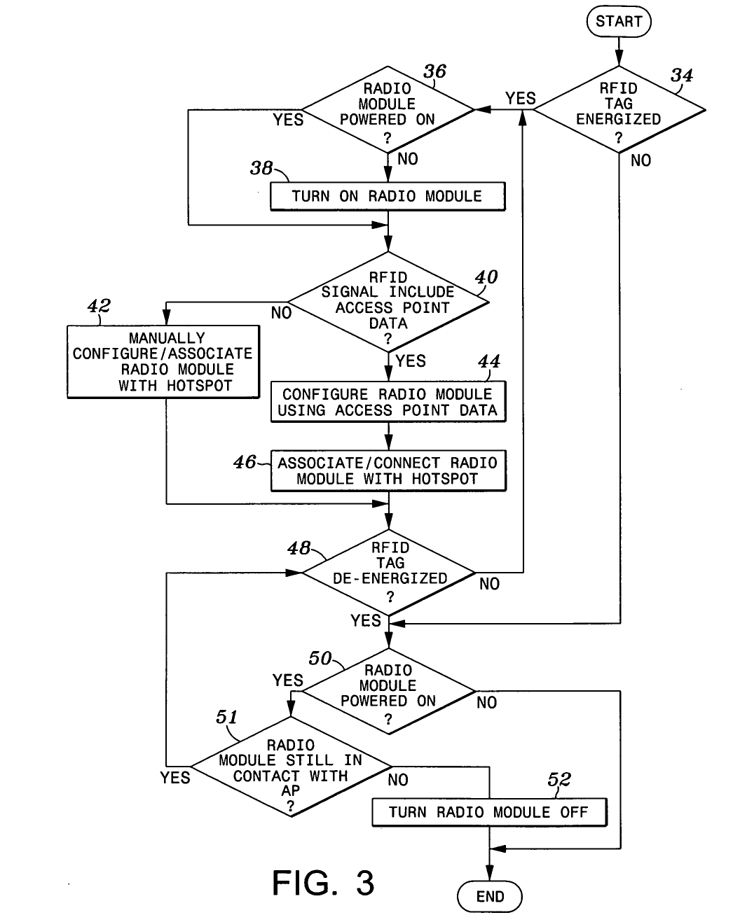

FIG. 3 is a flow diagram illustrating an embodiment of a wireless hotspot detection method. In the embodiment illustrated in FIG. 3, the method begins at block 34 where a determination is made whether RFID tag 22 is energized, such as when electronic device 12 enters the broadcasting area of transmitter 28 (e.g., the hotspot). If RFID tag 22 is energized, the method proceeds to decision block 36, where a determination is made whether radio module 26 is powered on. If radio module 26 is not powered on, the method proceeds to block 38, where tag 22 notifies and/or otherwise signals processor 20 to turn on and/or otherwise power radio module 26 to facilitate communications with communication network 18. The method proceeds to block 40. At decision block 36, if a determination is made that radio module 26 is powered on, the method proceeds to block 40. If at decision block 34 a determination is made that RFID tag 22 is not energized, the method proceeds to decision block 50.

At decision block 40, a determination is made by hotspot detection module 15 whether access point data 32 was received by RFID transmitter 28. If access point data 32 was received, access point data 32 is communicated to radio module 26 to enable automatic configuration and association of radio module 26 with communication network 18, as illustrated at blocks 44 and 46. If at decision block 40 it is determined that no access point data 32 was received from RFID transmitter 28, radio module 32 is manually configured and/or associated with the communication network 18 hotspot, as indicated at block 42. At decision block 48, a determination is made whether RFID tag 22 has been de-energized. If it is determined that RFID tag 22 is no longer energized, such as for example, when electronic device 12 is moved outside the broadcast range of the broadcast RFID signal, the method proceeds to decision block 50, where hotspot detection module 15 determines whether radio module 26 is currently powered on. For example, if the geographic boundary covered by the broadcast RFID signal is less than the geographic boundary of the wireless hotspots, the RFID tag 22 may become de-energized while electronic device remains within the wireless hotspot. If radio module 26 is powered on, the method proceeds to decision block 51 where a determination is made whether radio module 26 is still in contact with AP 16. If radio module 26 is not in contact with AP 16, the method proceeds to block 52 where processor 20 sends a command to turn off radio module 26. If it is determined that radio module 26 is still in contact with AP 16, then the method proceeds back to block 48. If it is determined at decision block 48 that RFID tag 22 is not de-energized, the method proceeds to block 36. If it is determined at decision block 50 that radio module 26 is not powered on, the method ends.

Thus, embodiments provide a hotspot detection system 14 that automatically powers a radio module 26 upon detecting a hotspot and automatically turns off radio module 26 upon detecting that electronic device 12 is no longer in a hotspot (e.g., in response to electronic device 12 being moved beyond the hotspot) in order to reduce power consumption and thereby extend the life of battery 20.

What is claimed is:

1. A wireless hotspot detection system, comprising:
a hotspot detection module configured to detect a wireless hotspot and activate a wireless module in response to the detection of the wireless hotspot.

2. The system of claim 1, wherein the hotspot detection module comprises a radio frequency identification (RFID) tag to detect the wireless hotspot.

3. The system of claim 2, wherein the RFID tag is configured to detect the wireless hotspot based on a signal received from a wireless access point RFID transmitter.

4. The system of claim 1, wherein the hotspot detection module comprises a RFID tag configured to detect a signal indicative of at least one characteristic of the wireless hotspot.

5. The system of claim 1, wherein the hotspot detection module is configured to turn off the radio module in response to detecting an absence of a wireless hotspot.

6. The system of claim 1, wherein the hotspot detection module is configured to automatically configure the radio module in response to receiving access point data associated with the wireless hotspot.

7. The system of claim 1, wherein the hotspot detection module comprises a passive RFID tag for detecting the wireless hotspot.

8. A wireless hotspot detection method, comprising,
automatically turning on a radio module in response to detecting that the electronic device is located within a wireless hotspot.

9. The method of claim 8, further comprising detecting the wireless hotspot using a radio frequency identification (RFID) tag.

10. The method of claim 8, further comprising detecting the wireless hotspot based on receipt by a RFID tag of a signal transmitted from an access point RFID transmitter.

11. The method of claim 8, further comprising detecting a signal indicative of at least one characteristic of the wireless hotspot.

12. The method of claim 8, further comprising automatically turning off the radio module in response to detecting an absence of a wireless hotspot.

13. The method of claim 8, further comprising automatically configuring the radio module in response to receiving access point data associated with the wireless hotspot.

14. A wireless hotspot detection system, comprising:
means for automatically turning on a radio module means in response to detecting that the electronic means is located within a wireless hotspot.

15. The system of claim 14, further comprising a radio frequency identification (RFID) means for detecting the wireless hotspot.

16. The system of claim 14, further comprising means for receiving a RFID signal from an access point RFID transmitter means.

17. The system of claim 14, further comprising means for automatically turning off the radio module means in response to detecting an absence of a wireless hotspot.
